(19) United States
(12) Patent Application Publication
(10) Pub. No.: US 2023/0260537 A1
(43) Pub. Date: Aug. 17, 2023

(54) Single Vector Digital Voice Accelerometer

(71) Applicant: Google LLC, Mountain View, CA (US)

(72) Inventor: Craig Ranta, Kitchener (CA)

(21) Appl. No.: 17/673,174

(22) Filed: Feb. 16, 2022

(51) Int. Cl. G10L 25/78; H04R 3/00; H04R 1/10

(52) U.S. Cl. CPC G10L 25/78; H04R 3/005; H04R 1/1083; G10L 2025/783

(57) ABSTRACT

The technology generally relates to an accelerometer, such as a voice accelerometer, that may capture data from one or more coordinate axes. The accelerometer may be a component with an accessory, such as a pair of earbuds. The accessory may use the data captured by the accelerometer to determine whether a user wearing the accessory is speaking or whether someone else is speaking. For example, the accelerometer may capture vibrations data from the bony facial structure of the user from multiple axes. The data may be combined and/or formatted into a single data collection vector. The single data collection may be, for example, predetermined vector that is oriented to increase the sensitivity of the accelerometer. By combining the data into the predetermined vector, the data may be transmitted using pulse density modulation, which may use less power and, therefore, may increase the battery life of the device.

### BACKGROUND

Devices, such as a pair of earbuds, may include accelerometers, such as a voice accelerometer, to determine whether a user using the device is speaking. The accelerometer can be arbitrarily mounted on a printed circuit board inside the device. The accelerometer can collect data from a single axis (i.e. x, y, or z-axis) or from all three axes (i.e. x, y, and z-axis). Data collected from a single axis and/or all three axes may not be optimized to collect vibration data and/or increase the sensitivity of the accelerometer. This may result in the device failing to identify whether the user is talking and/or mistakenly identifying that the user is talking. Moreover, data from each axis is transmitted separately over a multichannel bus, which requires significant power, thereby draining the battery of the device.

### BRIEF SUMMARY

The technology generally relates to an accelerometer, such as a voice accelerometer, that may capture data from one or more coordinate axes. The accelerometer may be a component within a device, such as a pair of earbuds, smart glasses, smart helmet, AR/VR headset, etc. The device may use the data captured by the accelerometer to determine whether a user wearing the device is speaking or whether someone else is speaking. For example, the accelerometer may capture vibration data from the bony facial structure of the user from multiple axes. The data may be combined and/or formatted into a single data collection vector. For example, if the angles in three-dimension space of the predetermined vector is known, the vector amplitude may be determined using various formulas related to angles. For example, various combinations of sine, cosine, and tangent formulas may be used to determine the vector amplitude of the predetermined vector. The single data collection may be, for example, a predetermined vector oriented to increase the accelerometer's sensitivity. By combining and/or formatting the data into the predetermined vector, the data may be transmitted using pulse density modulation, which may require less power than sending separate data vectors from each axis and, therefore, may increase the battery life of the device.

One aspect of the technology is directed to an accelerometer comprising one or more sensors configured to capture data from two or more coordinate axes and one or more processors in communications with the one or more sensors, the one or more processors configured to combine the captured data into a single data collection vector, wherein the single data collection vector is oriented as a combination of the two or more coordinate axes.

The accelerometer may further include a single channel digital interface configured to transmit data from the single data collection vector. The accelerometer may be a voice accelerometer. The single data collection vector may be oriented towards a bony structure of a user when the device is in use. The data from the single data collection vector may include vibration data. The vibration data may be transmitted as an audio signal. The data from the single data collection may be an audio signal. The data may be transmitted to a second device and/or one or more processors of a device housing the accelerometer. The single data collection vector may be oriented in the x-axis, y-axis, and z-axis.

Another aspect of the technology is directed to a method comprising receiving, by one or more processors of an accelerometer in communication with one or more sensors of the accelerometer, data from two or more coordinate axes and combining, by the one or more processors, the received data into a single data collection vector, wherein the single data collection vector is oriented as a combination of the two or more coordinate axes.

Yet another aspect of the technology is directed to a non-transitory computer-readable medium storing instructions, which when executed by one or more processors, cause the one or more processors to receive, from one or more sensors of an accelerometer, data from two or more coordinate axes and combine the received data into a single data collection vector, wherein the single data collection vector is oriented as a combination of the two or more coordinate axes.

### BRIEF DESCRIPTION OF THE DRAWINGS

FIG. 1 is a pictorial diagram of an example system in use according to aspects of the disclosure.

FIG. 2 is a functional block diagram illustrating an example device according to aspects of the disclosure.

FIG. 3 is a functional block diagram illustrating an example system according to aspects of the disclosure.

FIG. 4 is a flow diagram illustrating a method according to aspects of the disclosure.

### DETAILED DESCRIPTION

The technology generally relates to an accelerometer having a predetermined vector. The predetermined vector may be used to capture data from the accelerometer in one or more axes. For example, an earbud from a pair of earbuds may use an accelerometer to determine whether a user is speaking or whether someone else is speaking. The accelerometer may capture data, such as vibrations of the user's bony facial structure, from multiple axes. The captured data may be combined and output as a single stream of data oriented in a predetermined direction. The data may be analyzed to determine whether it is the user speaking or someone else.

According to some examples, the predetermined vector may be a vector oriented in the x, y, and/or z-axis. According to some examples, the predetermined vector may be a vector that is oriented in at least two axes such that the accelerometer collects data from each of those axes. Additionally, or alternatively, the predetermined vector may be a single data collection vector that is the resultant of the data collected from each axis. The vector may be oriented to increase the sensitivity of voice pickup through bony structures in a user's head.

The accelerometer may be a voice accelerometer that can pick up and/or detect the voice of a user through bone conduction. The voice accelerometer may also be used to determine whether the user is speaking, as opposed to some other party.

Using a single vector oriented in three-dimensional coordinate axes such as the Cartesian coordinate system, the accelerometer may output a single stream of data. According to some examples, the accelerometer may capture multiple streams of data and combine them into a single stream of data from the perspective of the predetermined vector. For example, each stream of data may be a stream of data from a respective coordinate axis. For instance, a first stream of data may be from the x-axis, a second stream of data may be from the y-axis, and a third stream of data may be from the z-axis. A single predetermined vector that is oriented to obtain and/or combine data from two or more axes may simplify data collection. For example, the single vector may include data that is obtained from two or three different axes as compared to having a vector for each different axis, i.e. a first vector in the x-axis, a second vector in the y-axis, and a third vector in the z-axis.

The data may be, for example, the vibration information that is being collected by the voice accelerometer. The data stream may be an audio signal or a representation of an audio signal.

According to some examples, by combining data from two or more axis in a single vector, the data may be sent using less power over single-channel digital interface at a lower clock rate, as compared to having to send each individual vector data over a separate channel. For example, the data may be sent using pulse density modulation (“PDM”). Sending the data using PDM uses less power compared to sending up to three data streams over multi-slot digital audio or serial data paths, requiring the host to wake up, service and compute the optimal single vector. Thus, the battery life of the device may be increased using PDM. Additionally or alternatively, by combining data from two or more axes into a single vector and sending data using PDM, time alignment and latency may be improved as compared to sending data via multiple data digital audio streams. For example, PDM may be a direct form of digital audio that is inherent to a digital audio stream that can be time and/or phase aligned with other digital audio streams from digital microphones via PDM. Other forms of multiple data digital audio streams may carry data from all axes, however additional processing may be required upstream to produce a single, combined data vector. Other forms of digital data interfaces (e.g., I2C or SPI) may not be well aligned to other audio sources, such as PDM or I2S, and may introduce varying alignment and/or jitter as the data buffers for general purpose data digital interfaces may not be suited for audio-type signals. For example, the sample rates of other forms of digital data may not be aligned to audio rates of 8, 16, 24, and/or 48 kHz, for example.

The data may be transmitted to one or more processors within the device for processing. In this regard, the data may be processed to determine whether the user was speaking or whether the noise was caused by a source other than the user. According to some examples, once is it determined that it is the user speaker, rather than noise from another source, knowledge of the user speaking may be used to reduce noise. For example, the determination of the user speaking may be used as a speech gate to apply a noise canceller. Additionally or alternatively, knowledge of the user speaking may be used as an input to the device. For example, the speech of a user may be used as a wake-word detection and/or speech assistant. In some examples, determining that the user is speaking may be a gate, or an initial determining factor, to identify that the user spoke the wakeup command or the assistant word (e.g., “Hey, assistant”), as opposed to a person nearby speaking. Although the above-discussed example describes processing the data with processors of the device, in some instances the data may be transmitted to another device, such as a host device or server, for processing.

Devices, such as earbuds, AR/VR headsets, smartphones, and/or other wearable devices, may include a voice accelerometer. The voice accelerometer may be used to pickup the voice of a user in noisy conditions and/or to determine that the user is speaking. For example, the voice accelerometer may detect and capture vibrations from the bony structure of the user. The vibrations of the bony structure of the user, such as the jaw, may indicate that the user is talking or otherwise making noise.

The sensitivity of the voice accelerometer may be determined based on the axis of acceleration. Each axis, e.g. the x, y, and z-axis, may be a different axis of acceleration. By combining data collected from each axis into a single predetermined vector, the sensitivity of the device may be increased. For example, the vibration associated with human speech propagates in multiple directions (i.e. along multiple axes). The placement of the accelerometer in the device and/or the positioning of accelerometer with respect to the face of the user may be optimized such that the single predetermined vector of the accelerometer may capture data with the highest signal.

According to some examples, the predetermined vector may be oriented to optimize the sensitivity of the voice accelerometer based on where the voice accelerometer is located in relation to the bony structure of the user.

In some examples, the orientation of the predetermined vector may be determined based on where the accelerometer is mounted in the device in relation to the bony facial structure. For example, to increase the sensitivity and/or the amount of data captured by the accelerometer, the predetermined vector may be determined based on the type of device, the intended user, etc.

According to some examples, the predetermined vector may be determined based on samples from one or more users, as speech vibrations captured by the users may couple and propagate in different directions based on the design and fit of the device. Based on the samples, the predetermined vector may be oriented in the x, y, and/or z-axis.

In some examples, the orientation of the predetermined vector may be determined based on the design of the device. For example, the orientation of the predetermined vector may be in a first orientation when the device is a pair of earbuds and a second orientation when the device is an AR/VR headset. The orientation of the predetermined vector may be based on the design and/or fit of the device when being worn by the user.

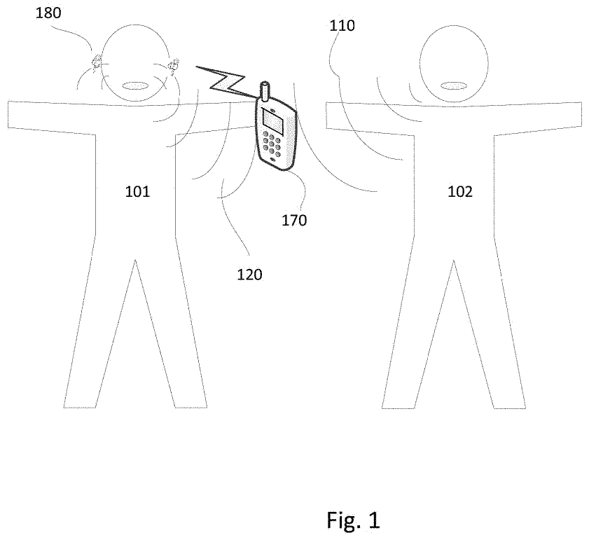

FIG. 1 is a pictorial diagram of an example system in use. A first user 101 is using two devices, such as an accessory 180 and a host device 170. Accessory 180 may be a device that is capable of wirelessly coupling to the host device 170. In some examples, accessory 180 may be a wearable device. While the accessory 180 is shown as a pair of earbuds, it should be understood that the accessory may be any of a number of other types of devices, such as smart glasses, smart helmets, AR/VR headsets, etc. Moreover, the accessory 180 may include a plurality of devices in communication with one another, such as a smartwatch in communication with wireless earbuds.

As shown in FIG. 1, the accessory 180 is wirelessly coupled to host device 170. The host 170 may be, for example, a mobile phone, such as a smart phone, tablet, laptop, gaming system, smart watch, etc. In some examples, the host device 170 may be coupled to a network, such as a cellular network, wireless Internet network, etc. For example, the user 101 may provide speech input 120 to host device 170, through accessory 180, for further transmission over a network to another device. However, in other examples accessory 180 may communicate directly over a network without host device 170.

In some scenarios, such as shown in FIG. 1, a second user 102 may also be speaking with or near the first user 101. Such speech 110 may be detected by accessory 180 and/or host device 170 and perceived as input. Accordingly, a microphone of accessory 180 may continue to receive the speech 110 of the second user 102, thereby draining a battery of accessory 180 and possibly triggering false commands. To avoid this, accessory 180 may detect speech 120 specific to the first user 101. For example, accessory 180 may include one or more accelerometers that detect movements of the first user 101 consistent with movement of the user's mouth, as would occur when the user is talking. According to some examples, at least one of the accelerometers may be a voice accelerometer. In such an example, the voice accelerometer may be a bone conducting microphone for measuring vibrations caused by the user 101 speaking. When such movement and/or vibration is detected, the microphone may automatically switch on to receive the speech 120 of the first user 101.

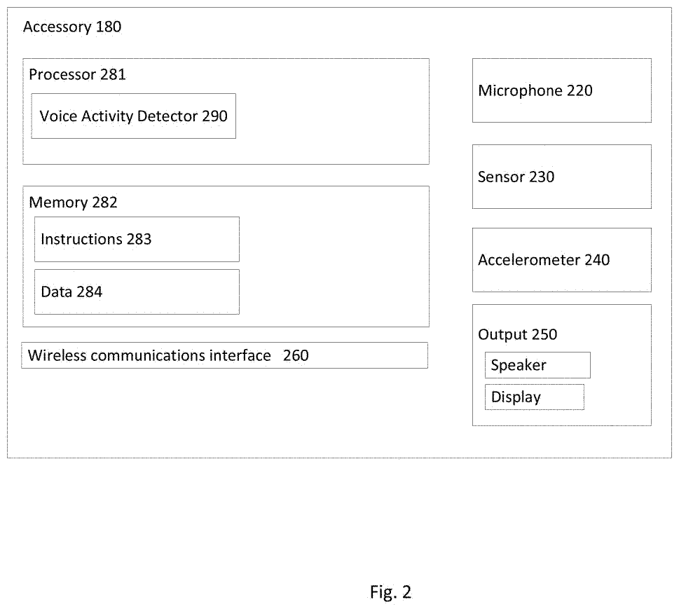

FIG. 2 illustrates example structural components of accessory 180 that provide for such detection of when a particular user provides speech input. While a number of example components are shown, it should be understood that additional or fewer components may be included. Moreover, multiple components of a same type, such as a plurality of processors, microphones, accelerometers, etc., may be included, despite that only one is shown in FIG. 2.

The accessory 180, as shown in FIG. 1, may include one or more processors 281 in communication with various other components, such as a memory 282, microphone 220, sensors 230, accelerometers 240, output 250, wireless communications interface 260, etc. For example, as described in more detail below, the one or more processors 281 may include a voice activity detector 382 that uses readings from the sensors 230 and/or accelerometers 240 to detect when a particular user is talking. The speech may be a voice command, such as “turn up the volume” or “shuffle songs on my favorite playlist.” In other examples, the speech may be dialogue to be transmitted over a network, such as during a telephone conversation with another user. A response to the input may be output to the user, such as by playing sounds through a speaker. In some cases, the output may include a display, such as for displaying images, text, videos, status information, or any other type of information.

The one or more processors 281 may be any conventional processors, such as commercially available microprocessors. Alternatively, the one or more processors may be an application specific integrated circuit (ASIC) or other hardware-based processor. Although FIG. 2 functionally illustrates the processor, memory, and other elements of accessory 180 as being within the same block, it will be understood by those of ordinary skill in the art that the processor, computing device, or memory may actually include multiple processors, computing devices, or memories that may or may not be stored within the same physical housing. Similarly, the memory may be a hard drive or other storage media located in a housing different from that of accessory 180. Accordingly, references to a processor or computing device will be understood to include references to a collection of processors or computing devices or memories that may or may not operate in parallel.

Memory 282 may store information that is accessible by the processors, including instructions 283 that may be executed by the processors 281. The memory 282 may be a type of memory operative to store information accessible by the processors 281, including a non-transitory computer-readable medium, or other medium that stores data that may be read with the aid of an electronic device, such as a hard-drive, memory card, read-only memory (“ROM”), random access memory (“RAM”), optical disks, as well as other write-capable and read-only memories. The subject matter disclosed herein may include different combinations of the foregoing, whereby different portions of the instructions 283 and data 284 are stored on different types of media.

Memory 282 may be retrieved, stored or modified by processors 281 in accordance with the instructions 283. For instance, although the present disclosure is not limited by a particular data structure, the data 284 may be stored in computer registers, in a relational database as a table having a plurality of different fields and records, XML documents, or flat files. The data 84 may also be formatted in a computer-readable format such as, but not limited to, binary values, ASCII or Unicode. By further way of example only, the data 284 may be stored as bitmaps comprised of pixels that are stored in compressed or uncompressed, or various image formats (e.g., JPEG), vector-based formats (e.g., SVG) or computer instructions for drawing graphics. Moreover, the data 284 may comprise information sufficient to identify the relevant information, such as numbers, descriptive text, proprietary codes, pointers, references to data stored in other memories (including other network locations) or information that is used by a function to calculate the relevant data.

The instructions 283 can be any set of instructions to be executed directly, such as machine code, or indirectly, such as scripts, by the processor 281. In that regard, the terms “instructions,” “application,” “steps,” and “programs” can be used interchangeably herein. The instructions can be stored in object code format for direct processing by the processor, or in any other computing device language including scripts or collections of independent source code modules that are interpreted on demand or compiled in advance. Functions, methods and routines of the instructions are explained in more detail below.

The processor 281 may include a voice activity detector 290 that detects when a specific user is talking. The voice activity detector 290 may be, for example, a software module executed by the processor 281 that uses information from the sensors 230, accelerometer 240, or other components to determine when a specific user is providing input. For example, the voice activity detector 290 may compare readings from the accelerometer 240 to a threshold.

The threshold may correspond to a level of movement and/or vibration that is consistent with a user talking. When the readings meet or exceed the threshold, it may be determined that the user is talking. The specific threshold may vary depending on, for example, a type of wearable device in which the accelerometer resides. For example, the threshold for earbuds may differ from the threshold for a head-mounted display. According to some examples, the threshold may be defined with respect to a noise floor. For example, the threshold may be 6 dB above the noise floor, 10 dB above the noise floor, etc.

While voice activity detector 290 is shown as part of processor 281, voice activity detector 290 may be a program executed by processor 281. In such an example, voice activity detector 290 may be instructions 283 to be executed by processor 281.

The microphone 220 may be any microphone capable of receiving sound as input. In addition to receiving speech input from the user, the microphone 220 may receive other sounds, such as background noise, other people talking, etc. In some examples, the microphone 220 may include multiple microphones positioned at different portions of the electronic device 180. By way of example only, a first beamformed microphone may be angled towards the user's mouth when the electronic device 180 is worn so as to receive the user's voice input, while a second microphone is positioned at an outer portion of the electronic device 180 to receive background noise or voice input from others that are interacting with the user.

The sensors 230 may include any of a variety of types of sensors. According to one example, the sensors 230 may detect whether accessory 180 is being worn by the user. For example, the sensors 230 may include capacitive sensors, thermal sensors, or other sensors for detecting whether accessory 180 is in contact with skin, thereby indicating whether the electronic device 180 is being worn.

According to some examples, accelerometer 240 may be a voice accelerometer. The accelerometer 240 may include one or more devices for detecting movement and/or vibration of the user that is consistent with the user talking. For example, referring back to FIG. 1, when the user 101 wearing accessory 180 begins talking, his mouth, jaw, and other parts of his body move. Such movement may indicate talking. The accelerometer 240 may also detect other types of movements that may be distinguished from the user talking. For example, while the accelerometer 240 may detect movements consistent with the user walking, typing, driving, etc., such movements can be distinguished from the talking movements and may be ignored. For example, motion may have a slower frequency response as compared to talking. While a person running may translate to approximately 3 Hz of frequency, a person talking may translate to approximately 100 Hz or more. Accordingly, a low pass filter may be placed at, for example, sub 10s of Hz or lower.

In examples where accelerometer 240 is and/or includes a voice accelerometer, when the user 101 wearing accessory 180 begins talking, his bony facial structure may begin vibrating. The voice accelerometer may pick-up the voice of user 101 through bone conduction such that the vibration of the bony facial structure may indicate talking.

According to some examples, the voice accelerometer may capture data from one or more coordinate axes. In some examples, the voice accelerometer may have a predetermined vector to capture data from the accelerometer in one or more axes. The predetermined vector may be oriented in a predetermined direction in the x, y, and/or z-axis. In such an example, data collected from each axis may be selected to fit within the predetermined vector. For example, data collected in the x-axis may be combined with data collected in the y or z-axis to correspond to the orientation of the predetermined vector. Therefore, while the orientation of the predetermined vector may be preset and/or predetermined, the data from each axis may be combined to correspond to the preset and/or predetermined orientation. According to some examples, the orientation of the predetermined vector may be preset and/or predetermined based on the type of device, the intended user, prior data collection sampling, etc.

According to some examples, the device, or system, may be trained to determine the predetermined vector based. For example, the device may instruct a user of the device to perform a series of actions and/or speak a series of verbal commands to determine the predetermined vector based on how the device fits the user. In some examples, after determining the predetermined vector, the predetermined vector may be written to the accelerometer.

In some examples, accelerometer 240 may include a microcontroller unit (“MCU”) and/or a digital signal processor (“DSP”). The MCU and/or DSP may detect gestures and/or perform feature extraction. Additionally or alternatively, the MCU and/or DSP may combine the data collected from one or more of the axes into the predetermined vector.

Accessory 180 may further include a wireless communication interface 260, such as an antenna, transceiver, pulse density modulation (“PDM”) interface, and any other devices used for wireless communication. The antenna may be, for example, a short-range wireless network antenna. The accessory 180 may be able to be coupled with host device 170 via a wireless connection. For instance, the antenna may be used to transmit and receive Bluetooth signals. There may be a maximum distance between accessory 180 and host device 170 that would allow accessory 180 and host device 170 to be within range of each other. Additionally or alternatively, the PDM interface may be used to send data between accessory 180 and host device 170. The data may include, for example, data captured by the accelerometer 240. According to some examples, PDM interface may be included in the same block as accelerometer 240.

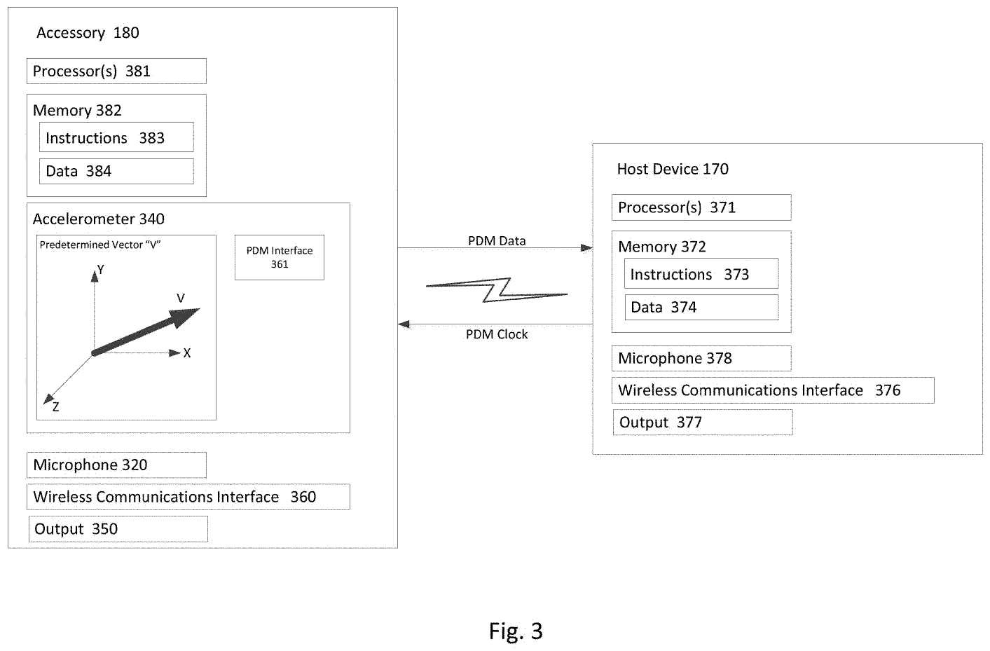

FIG. 3 provides an example functional block diagram of accessory 180 in communication with host device 170. Each device may include one or more processors 371, 381, memory 372, 382, and other components typically present in mobile computing devices and electronic devices that are substantially similar to those described above with respect to accessory 180 in FIG. 2. While a number of components are shown, it should be understood that such components are merely non-limiting examples, and that other components may additionally or alternatively be included.

As mentioned above, accessory 180 can be any of various types of devices, such as earbuds, head-mounted device, smart watch, etc. Host device 170 can also take a variety of forms, such as smart phone, tablet, laptop, game console, etc.

The instructions 383 may be executed to detect when the user is talking and to receive the user's voice input. For example, the instructions 383 provide for listening for and receiving user speech, for example, through microphone 320. The microphone 320 may be beamformed, such that it is directed to receive audio coming from a direction of the user's mouth. Additionally or alternatively, instructions 383 may provide for listening for user speech, for example, through accelerometer 340. For example, accelerometer 340 may detect vibrations in the bone structure of the face of a user and, based on the detected vibrations, the processors 381 may detect that the user is talking. In this regard, accessory 180 may recognize received speech as being that of the user, as opposed to other speakers that are not wearing accessory 180 or other background noise.

Accelerometer 340 may capture data, such as the vibrations of the user's bony facial structure as they speak, from multiple axes. For example, accelerometer 340 may capture data from at least one of the x, y, and/or z-axis. The capture data may be combined and output as a single stream of data oriented in a predetermined direction. For example, the data captured from each axis may be combined into a predetermined vector “V”. The predetermined vector “V” may be oriented in one or more of the three-dimensional coordinate axes, such as the x, y, and/or z-axis of the Cartesian coordinate system. According to some examples, when the data collected from each axis is combined, the combined data may correspond, or substantially corresponding, to the orientation of the predetermined vector “V”. Additionally or alternatively, when the data collected from each axis is combined, the combined data may be adjusted to fit the orientation of the predetermined vector “V”. In some examples, the accelerometer 340 may capture data in the x, y, and/or z-axis. In view of the predetermined vector “V”, the resulting magnitude of the predetermined vector “V” may be determined based on known angles between predetermined vectors “V” and the data from the x, y, and/or z-axis.

The sensitivity of the accelerometer 340 may be determined based on the orientation of predetermined vector “V”. For example, by combining each axis, e.g. the x, y, and/or z-axis, into predetermined vector “V”, the sensitivity of the device may be increased as vibration associated with human speech propagates in multiple directions and/or along multiple axes. According to some examples, predetermined vector “V” may be oriented to optimize the sensitivity of accelerometer 340 based on the placement of accelerometer 340 within accessory 180 and/or the positioning of accelerometer 340 with respect to the bony facial structure of the user when the user is using accessory 180.

To increase the sensitivity and/or the amount of data captured by accelerometer 240, the orientation of predetermined vector “V” may be determined based on the type of accessory, the intended user, etc. For example, when accessory 180 is a pair of earbuds, the predetermined vector “V” may be oriented in a first orientation based on the location of accelerometer 340 within the housing of the earbud, such as how close and/or far away accelerometer 340 is to the bony facial structure of the user when the earbud is being worn. In examples when the accessory is an AR/VR headset, predetermined vector “V” may be oriented in a second orientation, different than the first orientation of the earbuds.

The orientation of predetermined vector “V” may be based on whether accessory 180 is intended to be worn by a child or an adult. For example, an AR/VR intended to be worn by a child may be smaller than an AR/VR headset intended to be worn by an adult. The location and/or positioning of accelerometer 340 may differ between the child AR/VR headset and the adult AR/VR headset. In such an example, predetermined vector “V” for the child AR/VR headset may differ from predetermined vector “V” for the adult AR/VR headset. Predetermined vector “V” for the child AR/VR headset may differ from predetermined vector “V” for the adult AR/VR headset due to the differences in bony facial structure between a child and an adult. Thus, predetermined vector “V” may be different depending on the type of accessory 180, the intended user, etc.

In some examples, predetermined vector “V” may be determined based on samples from one or more users. The samples may be, for example, vibrations of the bony facial structure of users as they speak. The samples may be analyzed to determine a predetermined vector “V” for a given accessory type, intended user, etc.

The data collected by accelerometer 340 may be vibration information. According to some examples, the data may be in the form of an audio signal or a representation of an audio signal. Predetermined vector “V” that is orientated to obtain and/or combine data from each coordinate axis may simplify data collection. Additionally or alternatively, predetermined vector “V” may simply data transmission. For example, by using a single vector that is oriented in one or more coordinate axis, the accelerometer may output a single stream of data. The single stream of data may include data captured from each coordinate axis.

In some examples, the instructions 383 may further provide for transmitting data captured by accelerometer 340 to processors 381 within accessory 180 and/or host device 170 for processing. According to some examples, the data captured by accelerometer 340 may be PDM data. The PDM data may be transmitted from accelerometer 340 and/or accessory 180 to host device 170. The PDM clock may be a fixed clock signal used for a microphone and/or accelerometer to base data signals on. Predetermined vector “V” may allow for the data captured by accelerometer 340 to be transmitted using less power over single-channel digital interface at a lower clock rate, as compared to having to send data from each coordinate axis separately. According to some examples, the data may be transmitted using PDM. In some examples, the data may be transmitted via PDM interface 361. Additionally or alternatively, the data may be transmitted via wireless communications interface 360. While PDM interface 361 is shown as being within the same block as accelerometer 340, PDM interface 361 may be within the same block as wireless communications interface 360 or a separate block.

Transmitting data using PDM may use less power as compared to transmitting data from each axis over a multichannel bus and, therefore, may increase the battery life of the device. For example, sending the data using PDM uses less power as compared to sending up to data streams from each coordinate axis over multi-slot digital audio or serial data-path, requiring the host to wake up, service and compute the optimal single vector. Additionally or alternatively, transmitting data using PDM may allow host device 170 use less power. According to some examples, PDM may be a digital audio interface and the signal may be fed directly into audio processing units. In some examples, PDM may allow for two or more devices to be connected to the same interface. For example, a digital microphone and a PDM accelerometer may be paired to a single interface such that the single interface may include one or more speech detection sensors. Using other inputs may require additional power, which may increase the power required for each interface. For example, each additional input may require power for the input and/or output pads, buffers, MCUs to parse data and/or send signals to an audio subsystem for processing, etc.

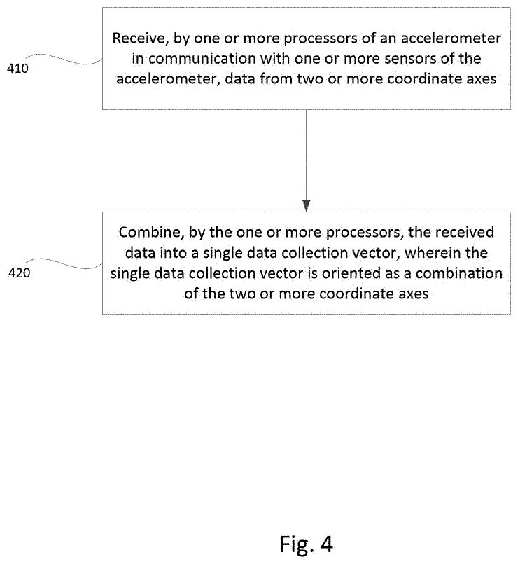

FIG. 4 illustrates an example method for combining data into a single data collection vector. The following operations do not have to be performed in the precise order described below. Rather, various operations can be handled in a different order or simultaneously, and operations may be added or omitted.

In block 410, one or more processors of an accelerometer in communication with one or more sensors of the accelerometer may receive data from two or more coordinate axes. The accelerometer may be within a housing of an accessory configured to be worn by a user. For example, the accessory may be a pair of earbuds, smart glasses, an AR/VR headset, a smart helmet, etc. The data may be, for example, vibration data. The vibration data may be collected from the bony structure of the user when the accessory is in use. According to some examples, the accelerometer may be a voice accelerometer. The accessory may use the data collected by the voice accelerometer to determine whether the user is speaking, whether another user nearby is speaking, or whether the noise is background noise.

In block 420, the one or more processors may be configured to combine the received data into a single data collection vector. The single data collection vector may be oriented as a combination of the two or more coordinate axes. In some examples, the single data collection vector may be oriented in the x-axis, y-axis, and z-axis. The orientation of the single data collection vector may be predetermined based on the type of accessory housing the accelerometer, the intended user of the accessory, the location of the accelerometer within the housing of the accessory, etc.

According to some examples, the method may additionally and/or alternatively include transmitting, by the one or more processors in communications with a single channel digital interface, the single data collection vector. For example, as the data from each coordinate axis is combined into a single data collection vector, the single data collection vector may be transmitted using a single channel digital interface instead of a multichannel bus. The single data collection vector may be transmitted to one or more processors of the accessory the accelerometer is housed within and/or one or more processors of a house device wirelessly coupled to the accessory. According to some examples, the combined data from the single data collection vector may be an audio signal. In such an example, the audio signal may be transmitted.

In some examples, the single data collection vector may be transmitted as PDM data via a PDM interface. This may allow for the single data collection vector to be transmitted using less power over a single channel digital interface, as compared to having to send data from each coordinate axis separately using a multichannel bus. Transmitting PMD data may use less power, which may increase the life of the battery of the accessory as compared to sending data from each coordinate axis over multi-slot digital audio or serial data-path.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. An accelerometer, comprising:
one or more sensors configured to capture data from two or more coordinate axes;
one or more processors in communications with the one or more sensors, the one or more processors configured to combine the captured data into a single data collection vector, wherein the single data collection vector is oriented as a combination of the two or more coordinate axes.

2. The accelerometer of claim 1, further comprising a single channel digital interface configured to transmit data from the single data collection vector.

3. The accelerometer of claim 1, wherein the accelerometer is a voice accelerometer.

4. The accelerometer of claim 1, wherein the single data collection vector is oriented towards a bony structure of a user when the device is in use.

5. The accelerometer of claim 1, wherein the data includes vibration data.

6. The accelerometer of claim 5, wherein the vibration data is transmitted as an audio signal.

7. The accelerometer of claim 1, wherein the combined data from the single data collection vector is an audio signal.

8. The accelerometer of claim 1, wherein the data is transmitted to a second device or one or more processors of a device housing the accelerometer for processing.

9. The accelerometer of claim 1, wherein the single data collection vector is oriented in the x-axis, y-axis, and z-axis.

10. A method, comprising:
receiving, by one or more processors of an accelerometer in communication with one or more sensors of the accelerometer, data from two or more coordinate axes; and
combining, by the one or more processors, the received data into a single data collection vector, wherein the single data collection vector is oriented as a combination of the two or more coordinate axes.

11. The method of claim 1, further comprising transmitting, by the one or more processors in communication with a single channel digital interface, the single data collection vector to at least one processor a host device or an accessory.

12. The method of claim 11, wherein the accelerometer is within a housing of an accessory configured to be worn by a user.

13. The method of claim 10, wherein the accelerometer is a voice accelerometer.

14. The method of claim 10, wherein the single data collection vector is oriented towards a bony structure of a user when the device is in use.

15. The method of claim 10, wherein the data includes vibration data.

16. The method of claim 15, further comprising transmitting, by the one or more processors in communication with a single channel digital interface, the vibration data as an audio signal.

17. The method of claim 10, wherein the combined data from the single data collection vector is an audio signal.

18. The method of claim 10, wherein the single data collection vector is oriented in the x-axis, y-axis, and z-axis.

19. A non-transitory computer-readable medium storing instructions, which when executed by one or more processors, cause the one or more processors to:
receive, from one or more sensors of an accelerometer, data from two or more coordinate axes; and
combine the received data into a single data collection vector, wherein the single data collection vector is oriented as a combination of the two or more coordinate axes.

20. The non-transitory computer-readable medium of claim 19, wherein the one or more processors are further configured to: transmit, via a single channel digital interface, the single data collection vector to at least one processor a host device or an accessory.
